(19) United States
(12) Patent Application Publication
(10) Pub. No.: US 2021/0390642 A1
(43) Pub. Date: Dec. 16, 2021

(54) DIGITAL SERVICE MANAGEMENT IN EDGE COMPUTING ELEMENTS OF CONTENT DELIVERY NETWORKS

(71) Applicant: OmniMesh Technologies, Inc., Syracuse, NY (US)

(72) Inventors: Joseph R. McCoy, Frankfort, NY (US); William Abrams, East Syracuse, NY (US); Francis Owen McInerney, Katonah, NY (US); Christopher M. Smolen, Oneida, NY (US)

(21) Appl. No.: 16/898,494

(22) Filed: Jun. 11, 2020

(51) Int. Cl. G06Q 50/18; G06F 16/23

(52) U.S. Cl. CPC G06Q 50/18; G06F 16/2315

(57) ABSTRACT

This document describes methods and systems for delivering digital services to nodes of a distributed network. To do this, an edge server that is communicatively connected to a communication network receives, from a consumer node, a service request for a first requested digital service. The edge server (acting as a digital resource broker) also will receive, from each a plurality of service provider nodes, an identification of one or more digital service element capabilities that the service provider node is able to provide. The digital resource broker will identify a set of service provider nodes who have identified digital service element capabilities that are components of the requested digital service. The digital resource broker will create a channel that includes the set of service provider nodes and, for each node, its identified capabilities that are components of the requested service. The digital resource broker will generate a smart contract that identifies the requested digital service, the set of service provider nodes, and the identified digital service element capabilities that are components of the requested digital service. The digital resource broker will write the smart contract to a mutual distributed ledger and assign service elements to the nodes so that the digital service is delivered.

### BACKGROUND

The Internet and its adoption has created a global digital economy in which an ever-increasing number of devices are connected to the Internet, at an ever-increasing number of locations. Remote teleworking, the increasing number of Internet of Things (IoT)-connected devices, and other factors places increased strain on cloud computing system, as the increased demand for remote processing and data storage services tests the limits of system bandwidth and responsiveness.

To help improve response times and reduce bandwidth requirements, many networks are starting to rely on edge computing platforms. Edge computing is a distributed computing model in which various nodes of a communication network that are physically located in relative proximity to each other will share computation and/or data storage resources. Edge computing can be especially useful in content delivery networks, in which edge servers that are located close to users will serve audio and/or video content to those users. In recent years, the increase in usage of IoT devices provides additional opportunities to edge computing systems to reduce demand on remote servers.

However, as with cloud-based servers, the performance of edge servers is limited by the processing and data storage capacity of the server. There are locations and situations in which an edge server is not available. Also, even where edge servers are available, additional distributed processing and data storage capacity may be required. Individual users of a content delivery or other network may be able to provide such capacity. However, there is currently no reliable way to encourage or reward users who make their computing systems available to meet edge computing service needs. In addition, where edge servers are not available there is often a significant amount of latency between a user's service request and the actual delivery of service. This latency can be caused not only by computational and data storage capacity limitations, but also because of the time required to remotely verify the user's credentials and payment structure.

This document describes methods and systems that are directed to solving at least some of the issues described above.

### SUMMARY

This document describes methods and systems for delivering digital services to nodes of a distributed network. To do this, an edge server that is communicatively connected to a communication network may receive, from a consumer node that is communicatively connected to the communication network, a service request for a requested digital service. The edge server (acting as a digital resource broker) also will receive, from each a plurality of service provider nodes, an identification of one or more digital service element capabilities that the service provider node is able to provide. The digital resource broker will identify a set of service provider nodes who have identified digital service element capabilities that are components of the requested digital service. The digital resource broker will create a channel that includes the set of service provider nodes and, for each service provider node in the set, its identified digital service element capabilities that are components of the requested digital service. The digital resource broker will generate a smart contract that identifies the requested digital service, the set of service provider nodes, and the identified digital service element capabilities that are components of the requested digital service. The digital resource broker will write the smart contract to a mutual distributed ledger.

The system also may execute the smart contract. To do this, for each component of the requested digital service, the digital resource broker may determine whether one or more service provider nodes in the channel have identified digital service element capabilities that correspond to the component. When one or more service provider nodes in the channel have identified digital service element capabilities that correspond to the component, the digital resource broker may select one of those nodes and assign the component to the selected service provider node(s).

The digital resource broker may then monitor the channel to confirm that each selected service provider node provides the component. If a selected local node fails to provide the component, the digital resource broker may select an alternate service provider node and assign the component to the alternate service provider node. If a selected local node provides the component, the digital resource broker may generate a digital certificate for the selected local node and save the digital certificate to a mutual distributed ledger, which may or may not be the same mutual distributed ledger that holds the smart contract.

In some embodiments, the edge server/digital resource broker may also secure a remote component of the requested digital service from a cloud server that is communicatively connected to the communication network. If so, the digital resource broker may coordinate delivery of a local component of the first digital service and the remote component of the first digital service to the consumer node.

Example digital services that the system may facilitate include streaming media (audio and/or video), data storage, computer networking and/or computer processing functions. The service elements may include, without limitation data storage, computer networking or computer processing functions. For example, a local component of the requested digital service may be a data processing service, and the resource may be a processor. As another example, a local component of the requested digital service may be a data storage service, and the resource may be a memory device. The local component of the requested digital service also may be content streaming, and the service component may be streaming content that is stored in a memory of one or more of the service provider nodes.

Optionally, the digital resource broker may arrange for a secured payment amount having a value that corresponds to a value of elemental units of a digital certificate. The digital certificate also may be presented by the identified local node in exchange for the secured payment amount.

Optionally, the functions of the edge server may be distributed among two or more of the service provider nodes.

### BRIEF DESCRIPTION OF THE DRAWINGS

FIG. 1 illustrates a system by which various devices may provide computing capacity and collectively operate as a distributed computing system in an edge network.

FIG. 2 illustrates an example process for managing digital service asset delivery in an edge network.

FIG. 3 illustrates various functions that various elements of the system of FIG. 1 may provide.

FIG. 4 illustrates various hardware elements that or more electronic devices of the system may include.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

Additional terms that are relevant to this disclosure will be defined at the end of this Detailed Description section.

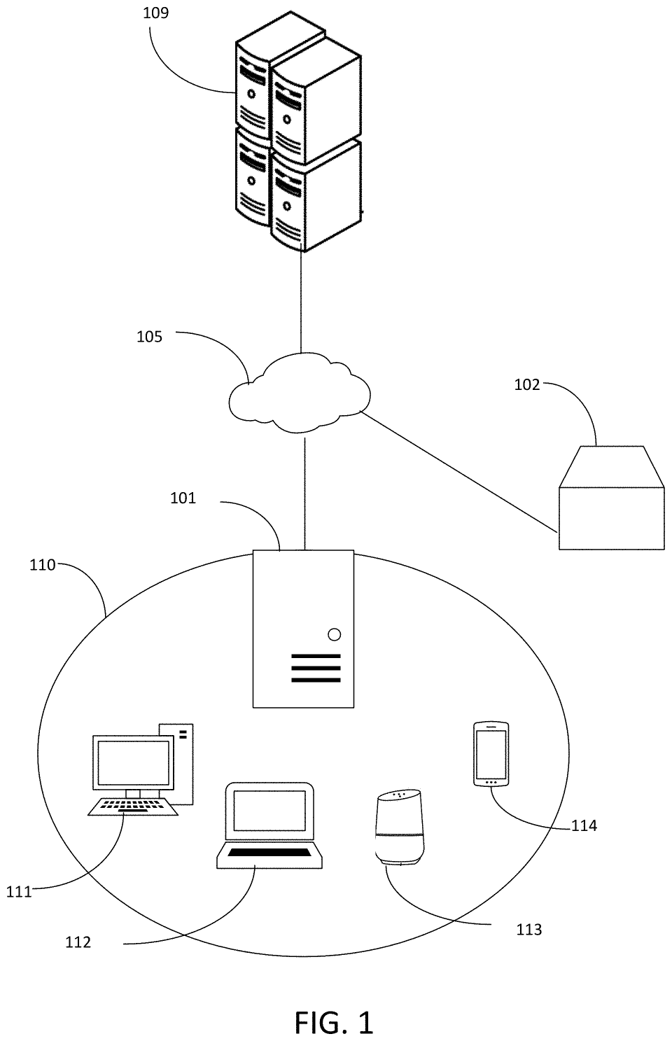

FIG. 1 illustrates a system in which a group of electronic devices 111-114 are communicatively connected to each other, at least some of which are communicatively connected using wireless communication protocols either directly or indirectly via an edge server 101, as part of an edge network 110. Optionally, one or more the electronic devices 111-114 also may be communicatively connected to one or more remote servers 109 via a communication network 105, which may be a single network or a group of interconnected networks. This connection may be direct, or indirect via the edge server. In addition, some or all of the electronic devices 111-114 may be communicatively connected to each other but not connected to any remote network. The remote server 109, when employed, may be one or more servers that provide a content delivery service such as an audio or video streaming service, a hosted provider of software-as-a-service, or some other digital service provider of digital services that can be delivered via a network. In addition, the electronic devices 111-114 may be communicatively connected to other devices on other networks, and all devices need not necessarily be part of a single edge network in some embodiments.

Any of the electronic devices 111-114 may be service consumers of content or other digital services that that the remote server 109 may supply. However, because the electronic devices will have a processor, a memory device, or both, any of the electronic devices 111-114 also may be resources that can help provide other service consumers with processing, data storage, networking or other computer-related capacity if needed, thus reducing the load that the remote server 109 must shoulder. In some situations, such as when a node stores content offline, this arrangement can even eliminate the need for a remote server 109 by allowing the content to be stored by and distributed among the nodes. Any electronic device may operate in a consumer state or a resource provider state, and each such device may include an installed software application with programming instructions to notify the edge server 101 and/or other electronic devices of the services that it requires (if in a consumer state) or can provide (if in a service provider state). In addition, the electronic devices 111-114 may operate together to collectively form a distributed computing system to meet service requirements of one or more devices in the edge network 110, with or without involving the remote server 109.

The electronic devices 111-114 shown may be relatively proximate to each other, such as in a same building, on a same street, or in a same neighborhood, although the invention is not limited to such an embodiment. If so, then the devices may be part of an edge network, and an edge server 101 may serve as a gateway between the edge network and the remote computing elements via the network 105. Multiple edge networks may be included in an overall system, with the edge networks being distributed over various geographic locations.

The edge server 101, remote server 109 or both may be communicatively connected with one or more other third party services 102. For example, the third party service 102 may be that of a financial institution or other holder of an asset reserve that participants in the system may use to back various modes of providing compensation for transactions that occur within the system.

The edge server 101 may provide various functions, such as that of a digital resource broker, a service element manager, and/or a wireless link orchestrator. These functions will be described in more detail below. In addition, the functions of the edge server 101 may be performed by one or more of the electronic devices 111-114 on the edge network so long as such devices have programming installed to perform the required functions. The edge server 101 may thus be a virtual machine and need not be an independent device, and if so the “edge server” may actually be a distributed, serverless system that can function in a decentralized form.

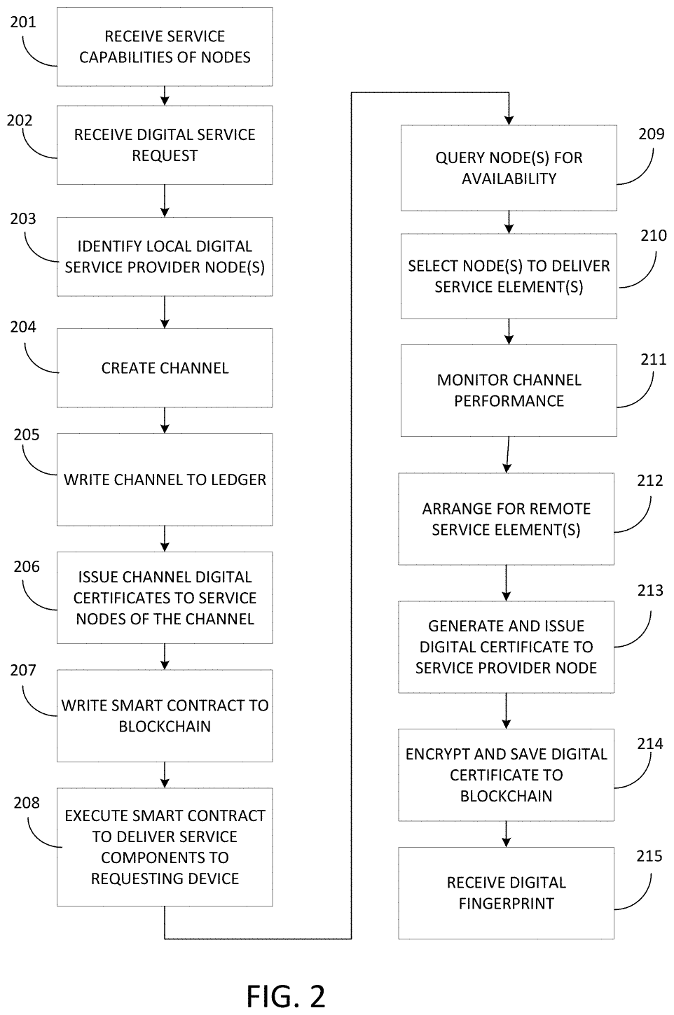

FIG. 2 illustrates a method of delivering digital services to nodes of a distributed network such as that in FIG. 1. An edge server that is communicatively connected to the network will receive service requests and operate as a digital resource broker to coordinate delivery of the requested service. The edge server will at least in part be one that is local to the requesting consumer node, such as (referring to FIG. 1) an edge server 101 of an edge network 110 to which the electronic devices 111-114, including a requesting consumer node (e.g., 113) and potential resource (service provider) nodes (e.g., 111, 112 and 114) are connected. In various embodiments the edge server may itself perform each of the steps below, or it may communicate with one or more other local or remote electronic devices that perform one or more of the described functions. In this description and the claims, when we say that an edge server performs the function, we mean that the edge server may perform the function itself and/or secure the function from one or more communicatively connected devices.

At 202 each resource node that is capable of providing a service will notify the edge server of the services that it is capable of performing. As noted above, electronic devices of the edge network may have available memory (data storage capacity), processing capabilities, networking capability (i.e., ability to relay data between nodes), stored content or other resources that they can make available to consumer devices. A node can make any of these resources available to other nodes as a service. For example, a node that is a set-top box may store digital video content that can be made available to other nodes that are authorized to view the content. Each resource node will have installed software that notifies the edge server of its available services by publishing its capabilities to the edge server, and optionally also publishing the capabilities to other devices on the network. For example, the software may check the device's available memory (using queries such as the “free” command in Linux or by checking system settings in Windows). This notification may occur automatically upon boot-up of a resource node, periodically during operation of the resource node, both of these, or at other times.

Any consumer node that is communicatively connected to the communication network may submit a first service request for a digital service. A consumer node may be any electronic device that is connected to a network, such as electronic devices 111-114 of FIG. 1. The requested digital service may include one or more digital content delivery services such as content delivery (i.e., streaming media, or downloading content), or the requested digital service may be a computing service such as hosted software as a service, data processing functions and/or data storage and retrieval. The consumer node may request the service by transmitting the request to the edge server, or by broadcasting the request to some or all other nodes (which may be the case where the edge server functions are distributed across the nodes).

To coordinate delivery of the service, at 203 the edge server may identify one or more nodes that are communicatively connected to the communication network and that have a resource for performing a local component of the requested service. The edge server will do this by matching the service request with the service provider node capabilities. At 204 the edge server will then create a channel, which is a data set that identifies a contingent of nodes that are capable of performing elements of the service (which may be referred to as “work units” or “service elements”). Each individual node may be assigned to one or more channels. At 205 the edge server will save a description of each node's capabilities to a mutual distributed ledger (a blockchain) so that each node's capabilities are viewable by other nodes of the edge network. Any or all of the nodes may store copies of the blockchain. At 206 the edge server will issue each node in the channel a digital certificate for the channel. Each channel digital certificate authorizes the service node to be included in a channel, and to provide services via the channel upon request. At this time, or earlier (such as upon receipt of a published service request), any or all nodes having availability to perform a service element may reserve the required resources in case they are selected to perform the service. For example, a service node may identify a memory sector that it will reserve to provide a storage service.

At 207 the edge server will then generate a smart contract and save the smart contract to the ledger. As is generally known, a smart contract is a computer program or transaction protocol that automatically executes to control or document legally relevant events according to terms of an agreement. In this case, the smart contract will include the consumer node as the first party to the contract, and the channel's service provider nodes as potential other parties to the contract. The contract will include the services that the consumer node requests, a time associated with the services, and the services that each channel service provider nodes has stated that it is able to provide. The system also may create or identify a unique mutual distributed ledger for each channel, and/or some mutual distributed ledgers may be used by multiple channels.

At 208 the smart contract will execute to coordinate delivery of the service elements to the consumer node. As noted above, the smart contract will identify several or all service nodes that are part of the channel. Therefore, multiple candidate nodes may be available to provide one or more of the service elements. In addition, not all nodes that have published capabilities may be available to actually provide the service element at a particular time. When executing the contract or at a different stage in the process, at 209 the edge server (service as a digital resource broker) system may query the nodes of the channel to determine which ones are available to provide the service element at the time. It may consider as candidate nodes to provide the service elements only those nodes that respond with availability within a threshold period of time. Then, at 210 the system may select one of the candidate nodes to provide each service element using any suitable selection process, such by random selection, by ranking the nodes based on past performance, or by other prioritization methods (such as by selecting a node that has not provided a service element within a particular time period, or by continuing to use a node that provided an immediately previous service element). The system may employ more detailed selection and assignment processes such as by using a Fibonacci sequence or other recurrence algorithm to schedule one or more of the service elements. The system will then assign the selected service provider nodes their service elements so that the selected service provider nodes can provide the service according to the schedule.

Notably, although each node will notify the edge server in advance of services that it can provide, various issues may prevent the node from providing the services at a given point in time. For example, wireless communication disruptions, heavier-than-usual local operations, or other issues may reduce or eliminate any node's ability to provide a service element. Thus, when coordinating delivery the system may first query a selected node to determine whether it is currently available to perform the service element. If the selected node replies within a threshold period of time, the edge server will assign the service element to the node; if not, the edge server will query additional nodes until it receives a response that a node is available, and it will then assign the service element to the available node. Alternatively, the system may query the availability of all nodes that are capable of performing a service element, wait to see which nodes response within a threshold period of time, and then select a node from the nodes that responded within availability and assign the service element to the selected node.

In addition, at 211 the edge server may monitor performance of a channel to ensure that all service elements are being provided in a timely manner. The system may wait for the service provider node, or the consumer that requested the service, to send a message confirming that the service element was complete. Alternatively, the system may verify completion using a consensus algorithm. In addition or alternatively, the edge server may run a state machine that knows the steps required to complete, which nodes have assigned work units (service elements), and metrics of acceptable work unit completion. The edge server may store the required steps and acceptable completion metrics in a data base in association with service categories and retrieve this information when a consumer node requests a particular service, or the consumer node may provide this information. Each service provider node may operate as a finite state machine when it implements the instructions. The service provider node will post its progress against each state in the finite states that make up the service, and the scheduler and/or consumer node may monitor these posts and use a consensus algorithm to confirm satisfactory completion. Time-based utilization of a resource can be a completion of the state. However, if the step function of the service exhibits unacceptable latency, too many transmission retries, failure to deliver required output, failure to report state (step function progress), or other negative indicators, the edge server and/or consumer node may conclude that the service provider node is not acceptably completing the service.

If the system cannot confirm that a selected node fails completed its service element within a particular time period after its assignment was generated, the edge server may identify a backup node by selecting an alternate node on the channel that is capable of performing the service element, and it will assign the service element to the backup node.

By arranging for delivery of service components via or by nodes that are located on the edge network, at locations that are much closer to the requesting entity than a remote server may be, the system can help to enable delivery of the service with much less latency than a service that is performed completely by a remote server. The nodes of the edge network thus become part of a distributed computer, which also may be referred to as a decentralized computer, in which multiple machines that are connected via a network collectively perform one or more computing functions by distributing the various components across various nodes. In this document, the terms “distributed” and “decentralized” may be used interchangeably to refer to a computer in which multiple physically separated nodes perform various elements of a computing process, and at least some of the nodes are in communication with the other nodes via a wireless connection.

Optionally, if the service request includes service elements that must be provided by a remote server (such as content delivery from a streaming media server), at 212 the edge server also may secure a remote component of the requested service from a remote server (i.e., a cloud server) that is communicatively connected to the communication network, such as by transmitting a service call message to the remote server.

Upon conformation of delivery of each service element by a local service provider node, or upon completion of a service contract, at 213 the edge server may generate a digital certificate that includes one or more elemental units (or elemental unit fractions) that the service provider node may present in exchange for a future digital service. An elemental unit is a credit or debit that may be exchanged for a service or other item of value. The service contract may be considered to be completed when no element of a service remains to be provided. Also at 213, upon completion of the service element and/or service contract, the edge server may issue the first digital certificate to the identified local node.

At 214 the system also may use a blockchain-based method of securing the digital certificates. For example, the system may use a hash function to generate a digital fingerprint of the first digital certificate. The system may then store the digital certificate to a mutual distributed ledger, and instead of providing the certificate to the service provider node it may provide the digital fingerprint to the service provider mode. Then, after issuing digital fingerprint to the local service provider node, at step 215 the service provider node may present the digital fingerprint to the edge server in order to redeem the signed digital certificate for a future service, or for other forms of value.

If multiple service provider nodes perform various service elements of a requested service, upon finalization of each element the system may save the digital certificate for each node to a blockchain, thus compensating the various service providers who provided the service. This blockchain may be the same blockchain that stores the smart contracts, or it may be an independent blockchain. If the consumer node is also a service provider note, the consumer node may present a previously-received digital certificate as payment. If so, the system may accept at least a partial value of the first digital certificate as a transactional exchange for the requested digital service.

In various embodiments, the system may determine the value of the digital certificate, and confirm that it is a trusted certificate, with very low latency and without having to verify a wallet or other payment source of the service requesting entity by checking the digital certificate against the locally-available blockchain.

In some embodiments, at 212 the edge server's digital resource broker function may arrange for a secured payment amount having a value that corresponds to a value of the digital certificate's elemental unit (described above). Any local node may thus present a digital fingerprint for a digital certificate in order to receive the secured payment amount, in addition to or instead of receiving service elements.

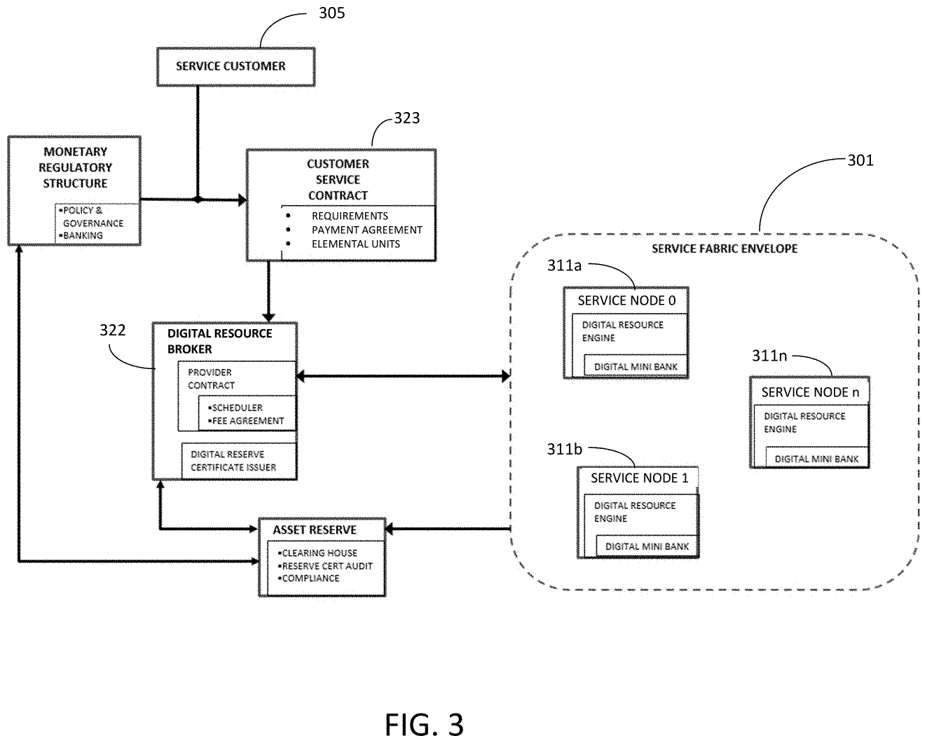

FIG. 3 illustrates various functions that elements of the system may provide. A service fabric envelope 301 will include various service nodes 311a . . . 311n that can provide digital resources such as processing, storage or other elements of a digital service. An edge server serves as a digital resource broker 322 to schedule services by assigning service elements to various service nodes as described above in FIG. 2. Although FIG. 3 shows the digital resource broker 322 as being outside of the service fabric envelope 301, as noted above the edge server (digital resource broker 322) may be made up of one or more of the nodes that are inside of the service fabric envelope 301. The service nodes 311a . . . 311n will publish their capabilities to the digital resource broker 322. The digital resource broker 322 may publish these capabilities to a mutual distributed ledger.

A service customer 305 may be a customer who requests a service from other nodes, or it may be a content provider who desires to make content available to various authorized nodes within the system. When a service customer 305 requests a service, the digital resource broker 322 will create a smart contract 323 and post the smart contract 323 to a mutual distributed ledger. The digital resource broker 322 will determine which nodes have published capabilities that meet requirements of one or more elements of the service. The digital resource broker 322 will then assign service elements to nodes that have the required capabilities as described in the discussion of FIG. 2. For example, if the service customer 305 is a content provider, the service element may be storage of the content by a node in its local memory. If the service customer 305 is a content consumer who is authorized to access the content, the service element may be streaming the digital content to the consumer, either directly or via one or more other nodes of the distributed computing system.

Upon consensus completion of a service element, the digital resource broker 322 will assign an elemental unit to the service provider who completed the element by posting the elemental unit 323 to the smart contract. Each service nodes 311a . . . 311n may be associated with what this document will refer to as a digital mini bank, which is a ledger of service elements (work units) that the service node performed, and value received for the service.

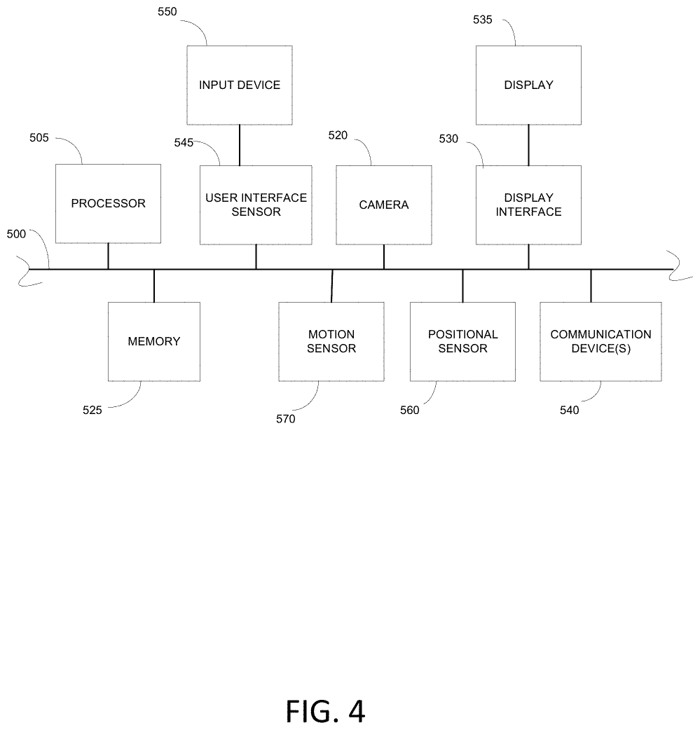

FIG. 4 depicts an example of internal hardware that may be included in any of the electronic components of the system, such as the user's smartphone or a local or remote computing device in the system. An electrical bus 500 serves as an information highway interconnecting the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 525. A memory device may include a single device or a collection of devices across which data and/or instructions are stored.

An optional display interface 530 may permit information from the bus 500 to be displayed on a display device 535 in visual, graphic or alphanumeric format. An audio interface and audio output (such as a speaker) also may be provided. Communication with external devices may occur using various communication devices 540 such as a wireless antenna, an RFID tag and/or short-range or near-field communication transceiver, each of which may optionally communicatively connect with other components of the device via one or more communication system. The communication device 540 may be configured to be communicatively connected to a communications network, such as the Internet, a local area network or a cellular telephone data network.

The hardware may also include a user interface sensor 545 that allows for receipt of data from input devices 550 such as a keyboard, a mouse, a joystick, a touchscreen, a touch pad, a remote control, a pointing device and/or microphone. Digital image frames also may be received from a camera 520 that can capture video and/or still images. The system also may include a positional sensor 580 and/or motion sensor 570 to detect position and movement of the device. Examples of motion sensors 570 include gyroscopes or accelerometers. Examples of positional sensors 580 include a global positioning system (GPS) sensor device that receives positional data from an external GPS network.

Terminology that is relevant to this disclosure includes:

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, set-top boxes, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 4.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The features and functions described above, as well as alternatives, may be combined into many other different systems or applications. Various alternatives, modifications, variations or improvements may be made by those skilled in the art, each of which is also intended to be encompassed by the disclosed embodiments.

1. A method of delivering digital services via nodes of a distributed network, the method comprising:
by an edge server that is communicatively connected to a communication network, wherein the edge server comprises a processor:
receiving, from each a plurality of wirelessly connected service provider nodes using a wireless communication protocol, an identification of one or more digital service element capabilities that the service provider node is able to provide, wherein each of the service provider nodes comprises an electronic device that is communicatively connected to the edge server via the communication network,
receiving, from a consumer node that is communicatively connected to the communication network and that comprises a processor, a first service request for a requested digital service,
identifying a set of the service provider nodes who have identified digital service element capabilities that are components of the requested digital service, wherein each of the service provider nodes also comprises a processor,
creating a channel that comprises the set of service provider nodes and, for each service provider node in the set, its identified digital service element capabilities that are components of the requested digital service,
generating a smart contract that comprises the requested digital service, the set of service provider nodes, and the identified digital service element capabilities that are components of the requested digital service, and
writing the smart contract to a mutual distributed ledger.

2. The method of claim 1, further comprising, by the edge server, executing the smart contract by, for each component of the requested digital service:
determining whether one or more service provider nodes in the channel have identified digital service element capabilities that correspond to the component; and
when one or more service provider nodes in the channel have identified digital service element capabilities that correspond to the component:
selecting one of those service provider nodes, and
assigning the component to the selected service provider node.

3. The method of claim 2, further comprising, by the edge server:
monitoring the channel to confirm that the selected service provider node provides the component;
if the monitoring determines that the selected service provider node fails to provide the component, selecting an alternate service provider node and assigning the component to the alternate service provider node; and
if the monitoring determines that the selected service provider node provides the component, generating a digital certificate for the selected service provider node and saving the digital certificate to the mutual distributed ledger.

4. The method of claim 1, further comprising, by the edge server:
securing a remote component of the requested digital service from a cloud server that is communicatively connected to the communication network; and
coordinating delivery of a local component of the requested digital service and the remote component of the first digital service to the consumer node.

5. The method of claim 1, wherein:
the requested digital service comprises streaming audio, streaming video, data storage, or computer processing functions; and
the identified service element capabilities comprise data storage, computer networking or computer processing functions.

6. The method of claim 1, wherein:
the requested digital service comprises streaming media; and
the identified service element capabilities comprise streaming digital media that is stored on in a memory of one or more of the service provider nodes.

7. The method of claim 2, further comprising:
by a digital resource broker, arranging for a secured payment amount having a value that corresponds to a value of an elemental unit of a digital certificate,
wherein the digital certificate is configured to be presented by the selected service provider node in exchange for the secured payment amount.

8. The method of claim 1, wherein:
the requested digital service is a data processing service, and the resource is a processor; and/or
a local component of the requested digital service is a data storage service, and the resource is a memory device.

9. The method of claim 8, further comprising, by the edge server:
securing a remote component of the first requested digital service from a cloud server,
wherein the cloud server comprises a streaming media service.

10. The method of claim 2, wherein selecting one of the service provider nodes and assigning the component of the first digital service to the selected service provider node comprises randomly selecting the selected service provider node from a set of candidate service provider nodes in the channel.

11. The method of claim 1, wherein the edge server is distributed across a plurality of the service provider nodes.

12. A system for delivering digital services via nodes of a distributed network, the system comprising:
a plurality of service provider nodes that are communicatively connected to each other via a wireless communication network, wherein each of the service provider nodes comprises a processor;
one or more memory devices that are accessible to the plurality of service provider nodes, each of which stores a mutual distributed ledger;
one or more processors; and
one or more memory devices that contain programming instructions that are operable to instruct the one or more processors to function as a digital resource broker that will:
receive, from a plurality of the service provider nodes, an identification of one or more digital service element capabilities that the service provider node is able to provide,
receive, from a consumer node that is communicatively connected to the communication network, a first service request for a requested digital service,
identify a set of the service provider nodes who have identified digital service element capabilities that are components of the requested digital service,
create a channel that comprises the set of service provider nodes and, for each service provider node in the set, its identified digital service element capabilities that are components of the requested digital service,
generate a smart contract that comprises the requested digital service, the set of service provider nodes, and the identified digital service element capabilities that are components of the requested digital service, and
write the smart contract to a mutual distributed ledger.

13. The system of claim 12, wherein the programming instructions that are operable to instruct one or more processors to function as a digital resource broker are also operable to instruct the one or more processors to execute the smart contract by, for each component of the requested digital service:
determining whether one or more service provider nodes in the channel have identified digital service element capabilities that correspond to the component; and
when one or more service provider nodes in the channel have identified digital service element capabilities that correspond to the component:
selecting one of those service provider nodes, and
assigning the component to the selected service provider node.

14. The system of claim 13, wherein the programming instructions for the digital resource broker are also operable to instruct the one or more processors to:
monitor the channel to confirm that the selected service provider node provides the component;
if the selected service provider node fails to provide the component, select an alternate service provider node and assign the component to the alternate service provider node; and
if the selected service provider node provides the component, generate a digital certificate for the selected service provider node and save the digital certificate to the mutual distributed ledger.

15. The system of claim 12, further comprising additional programming instructions that are operable to instruct the one or more processors to:
secure a remote component of the requested digital service from a cloud server that is communicatively connected to the communication network; and
coordinate delivery of a local component of the requested digital service and the remote component of the first digital service to the consumer node.

16. The system of claim 12, wherein:
the requested digital service comprises streaming audio, streaming video, data storage, or computer processing functions; and
the identified service element capabilities comprise data storage, computer networking or computer processing functions.

17. The system of claim 12, wherein:
at least one of the service provider nodes includes a memory that stores digital media; and
the programming instructions further comprise instructions to, when the requested digital service comprises streaming media, instruct one or more of service provider nodes that store the digital media to stream the digital media to the consumer node.

18. The system of claim 12, further comprising additional programming instructions that are operable to instruct the one or more processors to arrange for a secured payment amount having a value that corresponds to a value of an elemental unit of a digital certificate,
wherein the digital certificate also may be presented by the selected service provider node in exchange for the secured payment amount.

19. The system of claim 12, further comprising additional programming instructions that are operable to instruct the one or more processors to secure a remote component of the requested digital service from a cloud server,
wherein the cloud server comprises a streaming media service.

20. The system of claim 13, wherein the programming instructions to select one of the service provider nodes and assign the component of the requested digital service to the selected service provider node comprise instructions to randomly select the selected service provider node from a set of candidate service provider nodes in the channel.

21. The system of claim 12, wherein the digital resource broker is distributed across a plurality of the service provider nodes.
